(19) United States
(12) Patent Application Publication
(10) Pub. No.: US 2004/0023648 A1
(43) Pub. Date: Feb. 5, 2004

(54) Satellite telecommunication method and system and terminal therefor

(76) Inventors: Bertrand Raffier, Toulouse (FR); Serge Rainjonneau, Toulouse (FR); Pascal Piau, Lacroix Falgarde (FR)

Correspondence Address: SUGHRUE MION, PLLC, 2100 PENNSYLVANIA AVENUE, N.W., WASHINGTON, DC, 20037, US

(21) Appl. No.: 10/333,756

(22) PCT Filed: Jul. 12, 2001
(86) PCT No.: PCT/FR01/02262

(30) Foreign Application Priority Data
Jul. 27, 2000 (FR) 00 09836
Sep. 5, 2000 (FR) 00 11286

(51) Int. Cl. H04Q 7/20

(52) U.S. Cl. 455/422.1; 455/427

(57) ABSTRACT

The invention relates to a telecommunication method using a constellation of terrestrial satellites in which remote terminals communicate via a plurality of satellites communicating via direct links. The method is characterized in that the constellation of satellites has at all times a track on the Earth consisting of a single curve (26) and in that communications are transmitted from one satellite to another along the single curve. The constellation is a Walker constellation, for example.

The invention relates to a satellite telecommunication method and system.

It relates more particularly to a system in which the connection between two points on the terrestrial globe is effected only by means of one or more satellites.

A system of the above kind avoids the use of a terrestrial network. Distant terminals communicate via a plurality of satellites: the message from a sending first terminal is sent to a first satellite which transmits it via an intersatellite link to an adjacent satellite, and so on, as far as the satellite nearest the destination terminal.

The Iridium® telecommunication system is the only one until now that has used intersatellite links. Intersatellite links are difficult to manage, however.

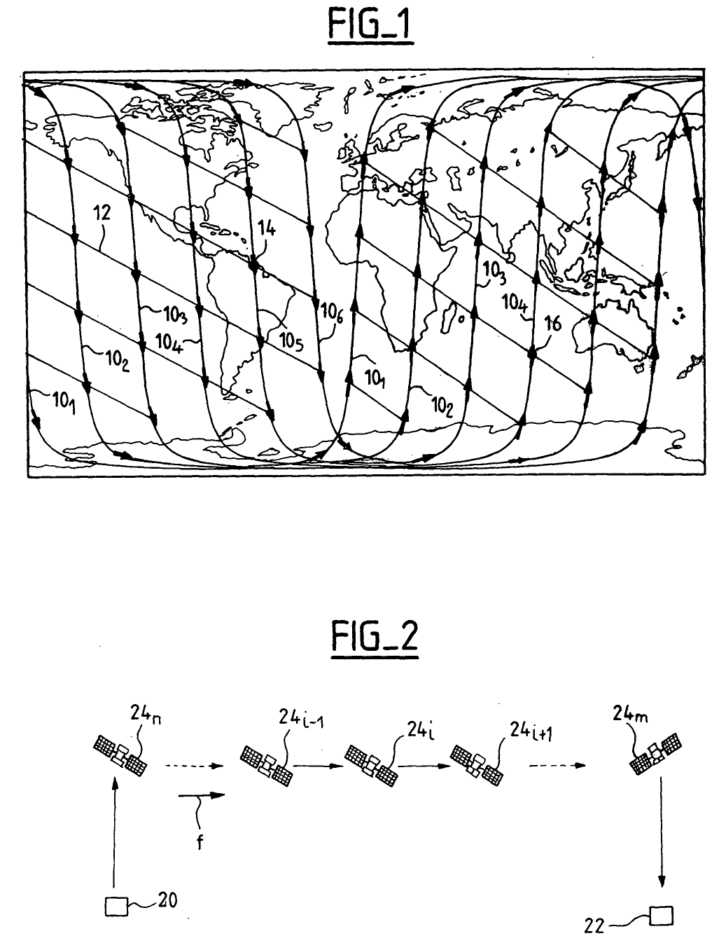

To illustrate these system management problems, FIG. 1 shows a world map with the tracks of the satellites on the surface of the Earth. Each arrow represents one satellite and the direction of the arrow shows the direction of its movement. At all times, the trajectories of the satellites are projected onto the Earth along six lines 10₁, 10₂, 10₃, 10₄, 10₅ and 10₆. Intersatellite link management does not cause problems if the satellite assigned to the sending (or destination) terminal is on the same line 10₁ as the satellite assigned to the destination (or sending) terminal. In this case, communications are North-South, i.e. on the same line. On the other hand, if the two satellites are on different curves, it is necessary to communicate on East-West links such as the link 12. For example, if the satellite 14 on the curve 10₅ is to communicate with the satellite 16 on the curve 10₄, which is almost at the antipodes of the position of the satellite 14, there are several eligible paths and choices must therefore be made. Managing this is not a simple matter and makes a significant contribution to communication costs.

The invention remedies this drawback.

It is characterized in that it uses a constellation of satellites, in which, at all times, the track of the satellites on the Earth is on a single curve and in that communications are transmitted by intersatellite links along the single curve.

Means are preferably provided for determining the direction of the single curve, for example that which corresponds to the shortest distance.

Managing the intersatellite links or connections is therefore particularly simple. The only choice that may need to be made is the direction.

One example of a constellation of satellites having at all times a single track on the Earth is a Walker constellation in which the satellites are distributed uniformly over the track. The invention is not limited to this type of constellation, however. It also encompasses single-track constellations with any distribution of the satellites over the curve.

In one embodiment, to determine the direction in each satellite, a database is provided indicating the area in which each terminal is located. Accordingly, when a satellite receives a call, means are provided for determining the terrestrial area of the called terminal and thus for deducing the direction therefrom.

The database on board each satellite can be updated by having a terminal that changes area send a message to the satellite in view from the terminal. The message received by one satellite is then transmitted to all the other satellites.

The invention also provides a terminal for implementing a telecommunication method according to the invention.

The terminal is characterized in that, for sending, it includes means for sending with messages to be transmitted the address of the destination terminal or the addresses of the destination terminals and an identifier of the telecommunication system which includes a constellation of satellites whose terrestrial track forms a single curve at all times, the connections from one satellite to another being effected along that curve, and in that, for receiving, the terminal includes means for recognizing messages assigned the identifier of the above kind of telecommunication system.

Other features and advantages of the invention will become apparent from the description of embodiments of the invention given with reference to the accompanying drawings, in which:

FIG. 1, already described, represents a constellation of satellites of a prior art telecommunication system,

FIG. 2 is a diagram illustrating the method according to the invention, and

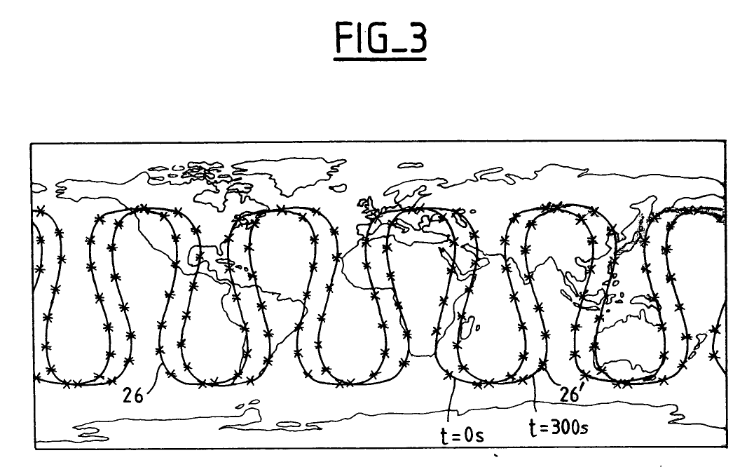

FIG. 3 is a diagram showing the track on the Earth of a constellation of satellites of a system according to the invention at two times separated by five minutes.

The invention consists in having two terminals 20 and 22 (FIG. 2) communicate exclusively via equipment on board satellites 24ₙ, . . . , 24ᵢ₋₁, 24ᵢ₊ⱼ, 24m and choosing the constellation of satellites so that at all times it has a single track 26 on the Earth (FIG. 3).

Furthermore, a satellite can communicate only with its two neighbors, i.e. the preceding satellite and the following satellite. Accordingly, the satellite 24ᵢ₋ₗ; can communicate only with the satellite 24ᵢ₊₁ and the satellite 24ᵢ₊₁. As shown in FIG. 2, the sending terminal 20 first transmits a message addressed to the receiving terminal 22 to the satellite 24ₙ visible from the terminal 20, and communications received by the satellite 24n are transmitted to the satellite 24m visible from the terminal 22 along the line 26.

There are only two ways for the satellite 24n to communicate with the satellite 24m, either as shown by the arrow f on the curve 26 or in the opposite direction. The shorter path is preferably chosen.

Once the direction has been determined, there is no routing to be effected since the messages simply follow the curve 26 in a particular direction.

In this example, the constellation is a Walker constellation. It is to be noted that a satellite constellation of this kind has already been used for telecommunications, but without using intersatellite links. Prior art telecommunication systems using Walker constellations communicate via base stations and terrestrial networks, each satellite providing communications between the terminals in one area and the base station of that area. In other words, unlike the invention, these prior art telecommunication systems do not utilize the property of Walker constellations of having at all times a track on the Earth that consists of a single curve.

Note further that a telecommunication system conforming to the invention can use the same satellites as a conventional telecommunication system using base stations and a Walker satellite constellation or, more generally, a satellite constellation having at all times a track on the Earth consisting of a single curve. In this way it is possible to optimize the use of the satellites, which are used by two telecommunication systems, namely a system conforming to the invention, which communicates only via intersatellite links, and a system which communicates via base stations.

Each terminal 20 is provided with sending and receiving means appropriate to the telecommunication method employed. A terminal 20 that sends a message transmits it with the address of the destination terminal 22, or the addresses of a plurality of destination terminals, and with data characteristic of the telecommunication system, so that the satellite 24n can recognize it and route it. Each satellite is equipped with means for determining the circulation direction f of the message to be transmitted. Similarly, a signal received by a terminal 22 is accompanied by an identifier specific to the telecommunication system.

Thus the invention relates not only to a telecommunication method and system, but also to each of its components, namely a send and/or receive terminal and the equipment on board each satellite.

It will be noted that, although the constellation at all times forms a single line 26 on the Earth, that line moves. Thus FIG. 3 shows a curve 26 representing the track of the constellation on the Earth at time t=0 and a curve 26′ that represents the track of the constellation 300 seconds later.

1. A telecommunication method using a constellation of terrestrial satellites in which remote terminals (20, 22) communicate via a plurality of satellites communicating via direct links, which method is characterized in that the constellation of satellites has at all times a track on the Earth consisting of a single curve (26) and in that communications are transmitted from one satellite to another along the single curve.

2. A method according to claim 1 characterized in that, in a first satellite (24n) receiving a message from a terminal (20), the direction of the single curve (26) for reaching the satellite (24m) intended to transmit the message to a destination terminal (22) is determined.

3. A method according to claim 2 characterized in that the direction is chosen so that the distance from the first satellite to the last satellite is the shortest.

4. A method according to any preceding claim, characterized in that each satellite is assigned a database indicating the terrestrial area in which each terminal is located.

5. A method according to any preceding claim characterized in that the constellation of satellites is a Walker constellation.

6. A terminal for a telecommunication system adapted to send and/or receive signals to or from a remote other terminal, terminals communicating via send and receive equipment on board satellites communicating directly with each other, which terminal is characterized in that, for sending, it includes means for sending with messages to be transmitted, in addition to the address of the destination terminal or the addresses of the destination terminals, an identifier of the telecommunication system which includes a constellation of satellites whose terrestrial track forms a single curve (26) at all times, the connections from one satellite to another being effected along that curve, and in that, for receiving, the terminal includes means for recognizing messages assigned the identifier of the above kind of telecommunication system.
